(19) United States
(12) Patent Application Publication
(10) Pub. No.: US 2010/0310276 A1
(43) Pub. Date: Dec. 9, 2010

(54) TONER CARTRIDGE AND IMAGE FORMING APPARATUS

(75) Inventor: Yoshiharu HORII, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/792,528

(22) Filed: Jun. 2, 2010

Related U.S. Application Data
(60) Provisional application No. 61/183,663, filed on Jun. 3, 2009.

(51) Int. Cl. G03G 15/08

(52) U.S. Cl. 399/263

(57) ABSTRACT

A toner cartridge includes: a toner storing unit configured to store a toner; and an agitation paddle configured to rotate a spiral section, which extends in a spiral shape with a rotation axis as a spiral center, in the toner storing unit with the rotation axis as a rotation center to thereby agitate the toner in the toner storing unit.

### CROSS-REFERENCE TO RELATED APPLICATION(S)

This application is based upon and claims the benefit of priority from: U.S. provisional application 61/183663, filed on Jun. 3, 2009, the entire contents of each of which are incorporated herein by reference.

### FIELD

This specification relates to a technique that contributes to a reduction in the resistance of toner agitation by an agitation paddle in a toner cartridge.

### BACKGROUND

In the past, there is known a configuration for agitating a toner in a toner cartridge with an agitation paddle in the toner cartridge.

In the agitation paddle in the toner cartridge in the past, a member extending in a rotation axis direction of the agitation paddle and located at an end on the outer side in a rotation radial direction is linear.

When the member linearly extending in the rotation axis direction as explained above is rotated to agitate the toner, the linear member receives large resistance during the toner agitation. A driving load in driving to rotate the agitation paddle is also large.

In particular, a deposited toner in the toner cartridge generates large agitation resistance. The large agitation resistance causes breakage or an increase in cost due to necessity for use of a high-power motor.

### BRIEF DESCRIPTION OF THE DRAWINGS

FIG. 1 is a longitudinal sectional view of an image forming apparatus of an embodiment;

FIG. 2 is a schematic perspective view of the configuration of an agitation paddle K included in a toner cartridge CY;

FIG. 3 is a sectional view of the toner cartridge CY in the position of the supporting section 101 in the direction of a rotation axis A taken along a plane orthogonal to the direction of the rotation axis A near a supporting section 101;

FIG. 4 is a sectional view of the toner cartridge CY in the position of a supporting section 103 taken along the plane orthogonal to the direction of the rotation axis A;

FIG. 5 is a sectional view of the toner cartridge CY in the position of a supporting section 106 taken along the plane orthogonal to the direction of the rotation axis A; and

FIG. 6 is a side view of the agitation paddle K viewed from a V direction shown in FIG. 2.

### DETAILED DESCRIPTION

In general, according to one embodiment, A toner cartridge includes a toner storing unit and an agitation paddle. a toner storing unit store a toner. an agitation paddle rotates a spiral section, which extends in a spiral shape with a rotation axis as a spiral center, in the toner storing unit with the rotation axis as a rotation center to thereby agitate the toner in the toner storing unit.

An embodiment is explained below with reference to the accompanying drawings.

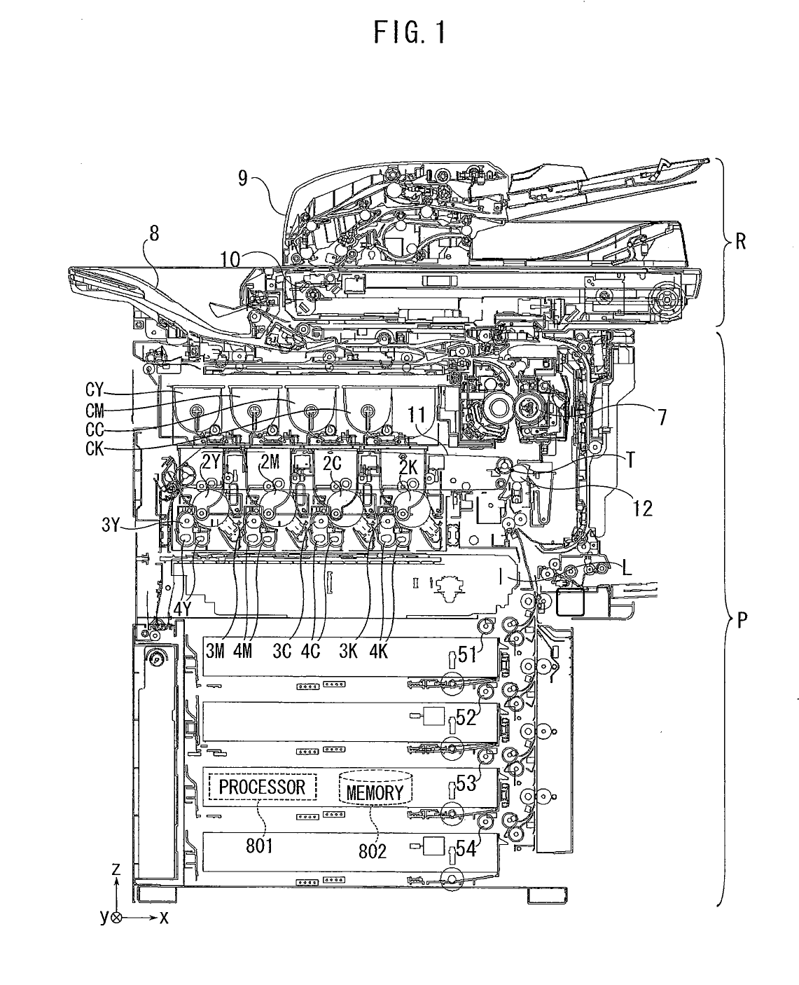

FIG. 1 is a longitudinal sectional view of an image forming apparatus.

The image forming apparatus includes an image reading unit R and an image forming unit P.

The image reading unit R scans and reads images of a sheet original document and a book original document.

The image forming unit P forms a developer image on a sheet on the basis of, for example, an image read from an original document by the image reading unit R or image data transmitted from an external apparatus to the image forming apparatus.

The image reading unit R reads an image of an original document.

The image forming unit P includes pickup rollers 51 to 54, photoconductive members 2Y to 2K, developing rollers 3Y to 3K, mixers 4Y to 4K, cleaning units 6Y to 6K, an intermediate transfer belt 11, a secondary transfer roller 12, a fixing device 7, a discharge tray 8, toner cartridges CY to CK, and a laser sweep unit L.

The image forming apparatus includes a processor 801 and a memory 802. The processor 801 performs various kinds of processing in the image forming apparatus. The processor 801 realizes various functions by executing computer programs stored in the memory 802.

An overview of copy processing in the image forming apparatus is explained.

First, the pickup rollers 51 to 54 convey sheets from cassettes to a sheet conveying path. Plural roller pairs convey the sheets to a secondary transfer position T.

The image reading unit R reads images of plural sheet original documents to obtain image data.

The laser sweep unit L forms, on the basis of the image data, electrostatic latent images on photoconductive surfaces of the photoconductive members 2Y, 2M, 2C, and 2K.

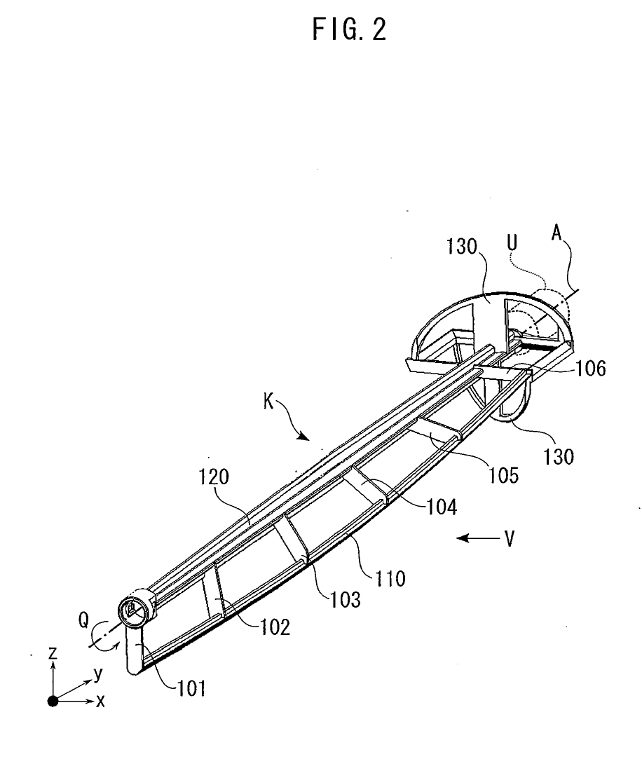

The mixers 4Y to 4K in developing devices agitate developers in the developing devices. The developing rollers 3Y to 3K supply the developers to the electrostatic latent images on the photoconductive members 2Y to 2K and visualize the electrostatic latent images on the photoconductive surfaces of the photoconductive members 2Y to 2K. The toner cartridges CY to CK supply toners to the developing devices. The toner cartridges CY to CK respectively include agitation paddles K. The image forming apparatus drives to rotate the agitation paddles K with a motor U shown in FIG. 2 and agitates the toners in the toner cartridges CY to CK.

The photoconductive members 2Y to 2K transfer developer images onto a belt surface of the intermediate transfer belt 11. The intermediate transfer belt 11 carries the developer images born on the rotating belt surface to the secondary transfer position T. The intermediate transfer belt 11 and the secondary transfer roller 12 nip and convey a sheet in the secondary transfer position T and transfer the developer images on the intermediate transfer belt 11 onto the sheet.

The fixing device 7 heats and fixes the developer images, which are transferred onto the sheet, on the sheet.

Plural conveying roller pairs sequentially discharge sheets having the developer images heated and fixed thereon onto the discharge tray 8.

The configuration of the toner cartridges CY to CK is explained. The toner cartridges CY to CK may have the same configuration.

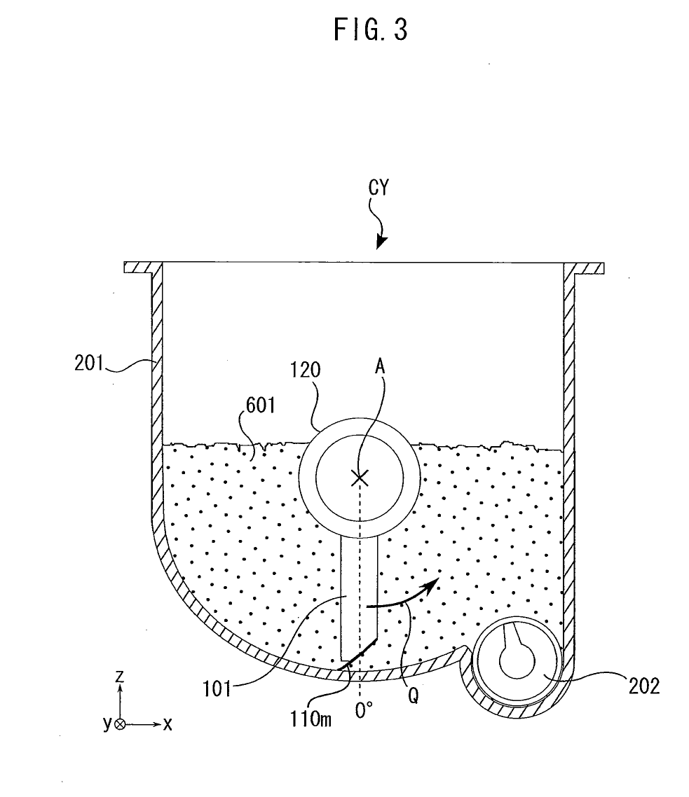

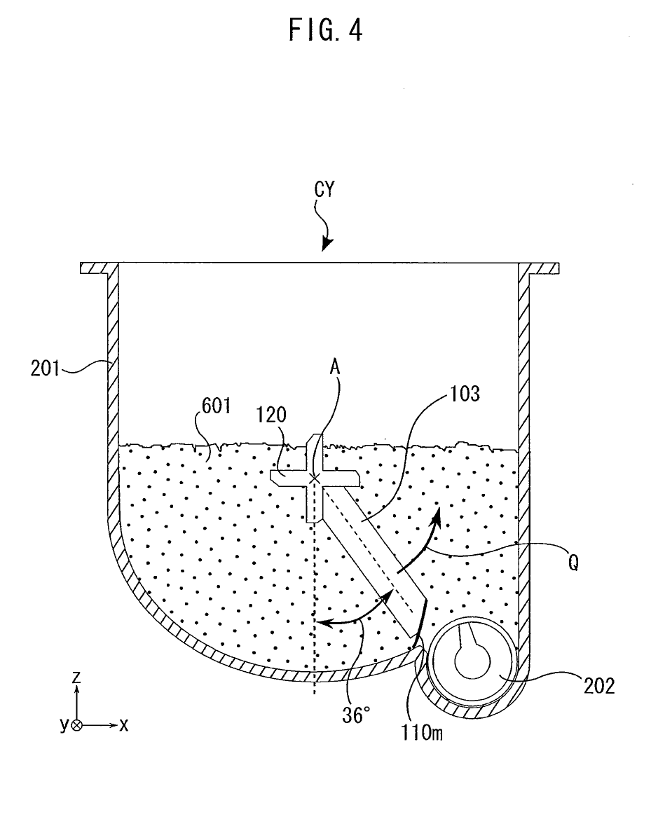

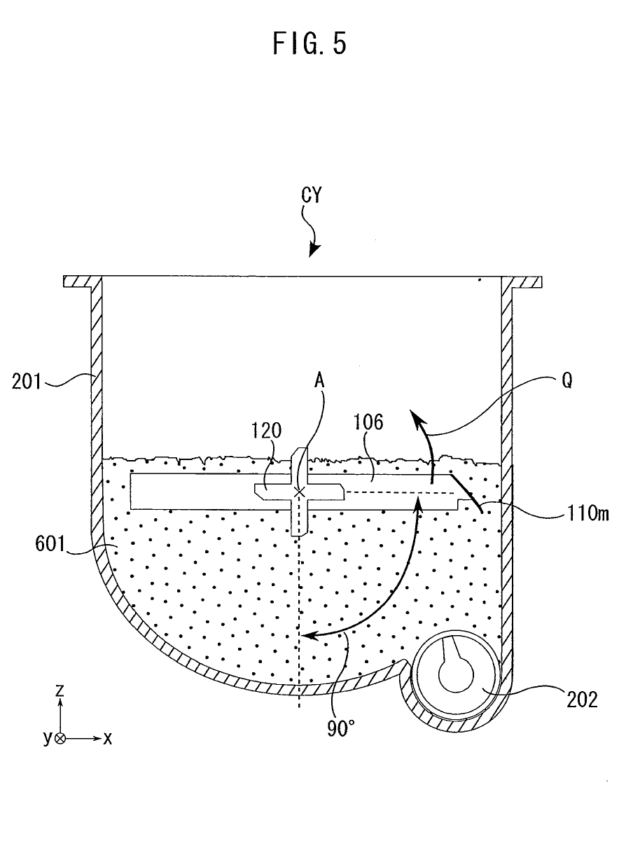

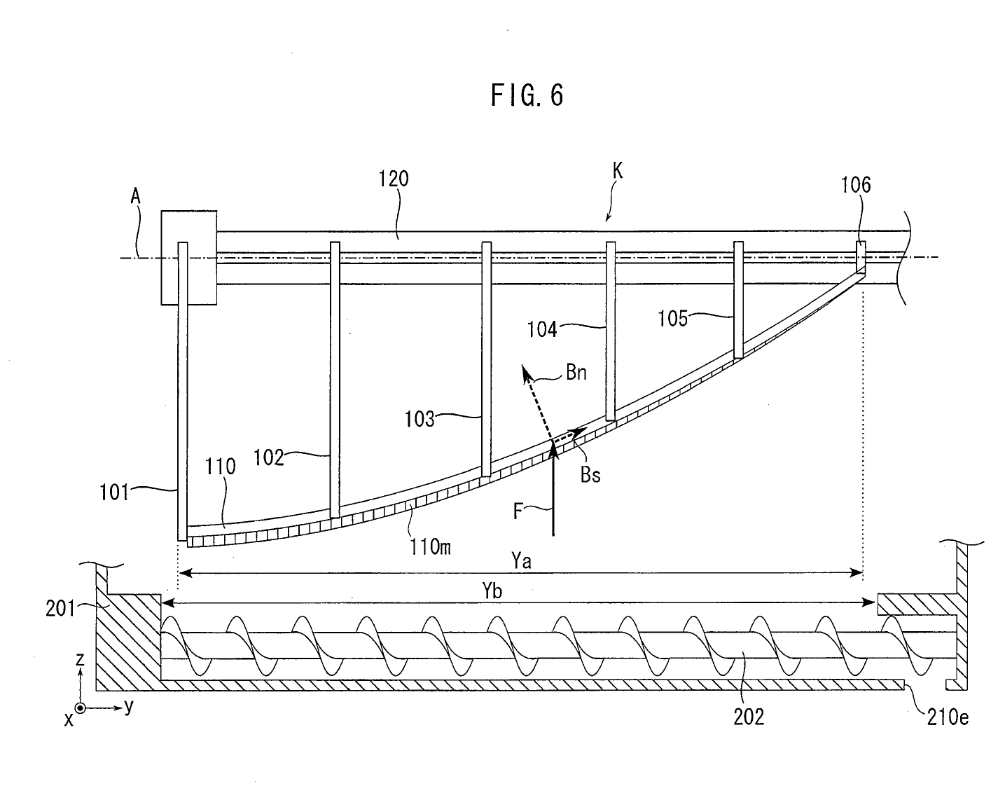

FIG. 2 is a schematic perspective view of the configuration of the agitation paddle K included in the toner cartridge CY. FIG. 3 is a sectional view of the toner cartridge CY in the position of the supporting section 101 in the direction of a rotation axis A taken along a plane orthogonal to the direction of the rotation axis A near a supporting section 101. FIG. 4 is a sectional view of the toner cartridge CY in the position of a supporting section 103 taken along the plane orthogonal to the direction of the rotation axis A. FIG. 5 is a sectional view of the toner cartridge CY in the position of a supporting section 106 taken along the plane orthogonal to the direction of the rotation axis A. FIG. 6 is a side view of a relation between the agitation paddle K viewed from a V direction shown in FIG. 2 and a carrying auger.

The toner cartridge CY includes a toner storing unit 201, the agitation paddle K, and an auger 202.

The toner storing unit 201 has a role of a container that stores a toner. The toner storing unit 201 has, at the bottom thereof, a discharge port 210e for discharging the toner in the toner storing unit 201 to the outside thereof.

The agitation paddle K rotates in the toner storing unit 201 with the rotation axis A extending in a longitudinal direction of the toner storing unit 201 as a rotation center.

The agitation paddle K includes a shaft section 120, plural supporting sections 101 to 106, a spiral section 110, and a discharge-port side paddle 130.

The spiral section 110 extends in a spiral shape with the rotation axis A as a spiral center.

The shaft section 120 extends in the direction of the rotation axis A extending in the longitudinal direction of the toner storing unit 201.

The plural supporting sections 101 to 106 are located in positions different from one another in the direction of the rotation axis A. The plural supporting sections 101 to 106 extend to the outer side in a rotation radial direction from the shaft section 120 and support the spiral section 110.

The discharge-port side paddle 130 is located on one end side in the shaft section 120. The discharge-port side paddle 130 agitates a toner present near the discharge port 210e of the toner storing unit 201.

The agitation paddle K is driven to rotate with the rotation axis A as a rotation center by the motor U to thereby agitate a toner 601 in the toner storing unit 201. The processor 801 controls the motor U.

The spiral section 110 has, from one end to the other end in the direction of the rotation axis A, an angle of twist equal to or smaller than 90 degrees with the rotation axis A as a spiral center. As an example, the spiral section 110 of the agitation paddle K shown in FIG. 2 has an angle of twist of 90 degrees. By setting the angle of twist of the spiral section 110 of the agitation paddle K to an angle equal to or smaller than 90 degrees, die cutting properties are improved and the number of dies in use can be reduced when, for example, the agitation paddle K is molded by dies.

The “angle of twist” indicates to which degree the spiral section 110 extending from one end (an end on the supporting section 101 side) to the other end (an end on the supporting section 106 side) of the agitation paddle K changes in terms of a relative angle position with respect to the rotation axis A.

At least a part of the carrying auger 202 is exposed in the toner storing unit 201. The carrying auger 202 carries the toner 601 stored in the toner storing unit 201 to the discharge port 201e.

The spiral section 110 is located in a range Ya narrower than “a range Yb in which the carrying auger 202 is exposed in the toner storing unit 201” in the direction of the rotation axis A. By setting Ya narrower than Yb, it is possible to surely move the toner mixed by the spiral section 110 to a range in which the auger 202 is present.

The spiral section 110 includes an elastic sheet 110m that inclines further to an upstream side in a rotating direction than the rotation radial direction and is set in contact with an inner wall surface of the toner storing unit 201.

The elastic sheet 110m has a tab shape in which at least an end on the outer side in the rotation radial direction is divided into plural sections in a direction in which the spiral section 110 extends.

The elastic sheet 110m projected to the outer side in the rotation radial direction of the spiral section 110 is divided into plural sections in the direction in which the spiral section 110 extends. This makes it possible to deform the divided sheet distal end sections independently from one another. When the toner in the toner storing unit 201 is agitated by the elastic sheet 110m of the spiral section 110, it is possible to prevent an excess load from being applied to the elastic sheet 110m. By preventing an excess load from being applied to the elastic sheet 110m, it is possible to prevent a rotation driving load of the agitation paddle K from increasing to an excess load.

When the toner cartridge CY is driven, the agitation paddle K rotates around the rotation axis A.

The agitation paddle K rotates while agitating the toner in the toner storing unit 201 of the toner cartridge CY. The spiral section 110 of the agitation paddle K has a spiral shape (a curved line shape). Therefore, toner agitation resistance force F applied to the spiral section 110 is divided into components of force Bs and Bn. It is possible to reduce a rotation load during the rotation driving of the agitation paddle K.

By forming a part of a member used for agitation in a spiral shape like the spiral section 110 in the agitation paddle K, it is possible to substantially reduce agitation resistance during toner agitation irrespectively of a state of the toner in the toner storing unit 201.

By reducing a rotation load of an agitation paddle in a toner cartridge, it is possible to realize a reduction in size of driving force transmitting mechanisms such as a motor functioning as a driving source for the agitation paddle and a gear that transmits driving force from the motor to the agitation paddle. This makes it possible to contribute to improvement of reliability through space saving and a reduction in cost of the entire image forming apparatus and a reduction in rotation driving load.

The present invention can be carried out in other various forms without departing from the spirit or the main characteristics of the present invention. Therefore, the embodiment is only an exemplar in every aspect and should not be limitedly interpreted. The scope of the present invention is indicated by the scope of claims and is by no means restricted by the text of the specification. Further, all modifications and various improvements, substitutions, and alterations belonging to the scope of equivalents of the scope of claims are within the scope of the present invention.

As explained above in detail, according to the technique described in this specification, it is possible to provide a technique that contributes to a reduction in agitation resistance in agitating a toner in a toner cartridge.

What is claimed is:

1. A toner cartridge comprising:
a toner storing unit configured to store a toner; and
an agitation paddle configured to rotate a spiral section, which extends in a spiral shape with a rotation axis as a spiral center, in the toner storing unit with the rotation axis as a rotation center to thereby agitate the toner in the toner storing unit.

2. The toner cartridge according to claim 1, wherein the agitation paddle includes a shaft section extending in a direction of the rotation axis.

3. The toner cartridge according to claim 2, wherein the agitation paddle includes plural supporting sections configured to support the spiral section in positions different from one another in the rotation axis direction.

4. The toner cartridge according to claim 3, wherein the plural supporting sections extend to an outer side in a rotation radial direction from the shaft section and support the spiral section.

5. The toner cartridge according to claim 1, wherein the spiral section is twisted, from one end to the other end in a direction of the rotation axis, at an angle of twist equal to or smaller than 90 degrees with the rotation axis as the spiral center.

6. The toner cartridge according to claim 1, wherein the toner storing unit has a discharge port which discharges the toner stored in the toner storing unit to an outside of the toner storing unit.

7. The toner cartridge according to claim 6, further comprising a carrying auger having at least a part thereof exposed in the toner storing unit and configured to carry the toner stored in the toner storing unit to the discharge port.

8. The toner cartridge according to claim 7, wherein the spiral section is located in a range narrower than a range in which the carrying auger is exposed in the toner storing unit.

9. The toner cartridge according to claim 1, wherein the spiral section has an elastic sheet that inclines further to an upstream side in a rotating direction than a rotation radial direction and comes into contact with an inner wall surface of the toner storing unit.

10. The toner cartridge according to claim 9, wherein, in the elastic sheet, at least an end on an outer side in the rotation radial direction is divided into plural sections in a direction in which the spiral section extends.

11. An image forming apparatus comprising:
a toner storing unit configured to store a toner;
an agitation paddle configured to rotate a spiral section, which extends in a spiral shape with a rotation axis as a spiral center, in the toner storing unit with the rotation axis as a rotation center to thereby agitate the toner in the toner storing unit;
a photoconductive member; and
a developing device configured to form a toner image on a photoconductive surface of the photoconductive member using the toner in the toner storing unit.

12. The apparatus according to claim 11, wherein the agitation paddle includes a shaft section extending in a direction of the rotation axis.

13. The apparatus according to claim 12, wherein the agitation paddle includes plural supporting sections configured to support the spiral section in positions different from one another in the rotation axis direction.

14. The apparatus according to claim 13, wherein the plural supporting sections extend to an outer side in a rotation radial direction from the shaft section and support the spiral section.

15. The apparatus according to claim 11, wherein the spiral section is twisted, from one end to the other end in a direction of the rotation axis, at an angle of twist equal to or smaller than 90 degrees with the rotation axis as the spiral center.

16. The apparatus according to claim 11, wherein the toner storing unit has a discharge port which discharges the toner stored in the toner storing unit to an outside of the toner storing unit.

17. The apparatus according to claim 16, further comprising a carrying auger having at least a part thereof exposed in the toner storing unit and configured to carry the toner stored in the toner storing unit to the discharge port.

18. The apparatus according to claim 17, wherein the spiral section is located in a range narrower than a range in which the carrying auger is exposed in the toner storing unit.

19. The apparatus according to claim 11, wherein the spiral section has an elastic sheet that inclines further to an upstream side in a rotating direction than a rotation radial direction and comes into contact with an inner wall surface of the toner storing unit.

20. The apparatus according to claim 19, wherein, in the elastic sheet, at least an end on an outer side in the rotation radial direction is divided into plural sections in a direction in which the spiral section extends.
